(19) United States
(12) Patent Application Publication
(10) Pub. No.: US 2003/0210770 A1
(43) Pub. Date: Nov. 13, 2003

(54) Method and apparatus for peer-to-peer voice communication using voice recognition and proper noun identification

(76) Inventor: Brian Krejcarek, Portland, OR (US)

Correspondence Address: MARGER JOHNSON & McCOLLOM, P.C., 1030 S.W. Morrison Street, Portland, OR, 97205, US

(21) Appl. No.: 10/435,318

(22) Filed: May 9, 2003

Related U.S. Application Data
(60) Provisional application No. 60/379,170, filed on May 10, 2002.

(51) Int. Cl. H04M 1/64

(52) U.S. Cl. 379/88.17; 379/88.01

(57) ABSTRACT

An Internet enabled or networked communication device facilitates peer-to-peer voice messaging and impromptu conversations between multiple users across a network. Embodiments of the invention provide direct or multiple party voice messaging and real-time communication over the Internet using a device controlled by voice commands. These embodiments create a more natural and informal method for engaging in conversation that increases the effectiveness of personal communication, particularly for those who are handicapped or have difficultly with conventional communication interfaces. Embodiments provide a simple, yet highly configurable system that enables users to securely communicate with each other in a peer-to-peer fashion without using a local server.

### CROSS-REFERENCE TO RELATED APPLICATIONS

This application claims priority from U.S. Provisional Patent Application 60/379,170, filed on May 10, 2002, the contents of which are hereby incorporated by reference in their entirety for all purposes.

### BACKGROUND OF THE INVENTION

1. Technical Field of the Invention

This disclosure relates generally to devices and methods used for voice communication over a network. Related technologies include standard telephone services such as voice and voice mail communications, mobile voice services, peer-to-peer and distributed networking, Voice over Internet Protocol (VoIP), Presence Management (PM), Instant Messaging (IM), and Instant Voice Messaging (IVM).

2. Description of the Related Art

Traditional voice (e.g., public switched telephone network, or PSTN), voice mail, and mobile voice communications are pervasive technologies. Although widely accepted, they are limited in several ways when compared to voice services offered over a global network such as the Internet. First, voice communications can be expensive from excessive control by telephone carriers and government regulations. Global networks offer a much lower-cost public infrastructure for the transmission of voice data. Second, the interface to voice communication devices typically requires a headset or clumsy speakerphone box. Third, conventional voice communication devices provide little information about user availability resulting in missed calls or messages.

Mobile services or wireless phones, of course, provide users communication services as they move from one location to another. However, they are also expensive and may carry complicated billing restrictions. They are usually limited by geographic region and often do not share the use of a common communication protocol from country to country. Furthermore, in a commercial or residential environment, wireless technology is not preferred because of battery power requirements and limited reception.

Recently, some mobile services and PSTN carriers have started to offer Internet-based features and connectivity. To date, these technologies are largely focused on web browsing, text-based Instant Messaging via keypad entry and text to speech and speech to text conversions, similar to those disclosed in United States Patent Application Publication No. 20020146097. United States Pat. App. Pub. 20020146097 also discloses “short voice messaging”, another technology used to send real-time voice messages that is similar to text-based Instant Messaging.

In some cases, these features enable traditional service users the ability to communicate with their Internet-based counterparts. Several carriers even offer VoIP capabilities through the use of VoIP gateways that connect the PSTN networks to the Internet. Nonetheless, they face many of the same limitations since the voice data must partially be carried over a private network and the interface remains the same.

VoIP is a technology based on sending voice data across the Internet in real-time. Most typical VoIP applications consist of computer programs that enable PC users to chat through a microphone and speaker connected to the PC. This interface is awkward and isolated, as users must be sitting in front of a computer to communicate. In some cases a regular analog telephone may be attached to the computer to simulate the same experience when talking over the PSTN. VoIP phones also exist in the form of regular analog telephones that don't require a PC. Nonetheless, they still require a traditional handset interface.

Instant Messaging (IM) is becoming an extremely popular communication method to informally communicate in real time. It facilitates text-based chat messaging across the Internet through an application that runs on an ordinary personal computer. Users type messages into a window and instantly send them to remote users. Messages can be sent directly to one person, or to a number of people associated with a group.

A number of recent software releases of these IM clients now include VoIP features such that in addition to text messaging, these users can engage in real-time voice communication or leave voice messages. IM users often get tied down to simply writing text messages back and forth. A voice chat feature makes for more effective communication. PC users can currently do this with a microphone and speaker attached to their PC. Again, the interface is clumsy and few people are comfortable sitting in front of their PC and talking to their computer.

Instant Messaging often employs another technology called Presence Management to help people better coordinate communication over the Internet. Most current implementations work as follows: When any particular user wishes to participate in an IM conversation, or be invited into a conversation, he or she must first log into what is known as an IM or presence server. This server monitors when the user is actually “on-line,” that is, their ability to be contacted by other users. This information is then indirectly available to those who wish to communicate with the other party and vice-versa. A PM system provides the information necessary to route calls or deliver messages directly to the intended recipient regardless of location. This is possible because the server “knows” or is notified of the location of the recipient.

A PM system provides a dynamic mapping between a conveniently remembered, unique, and static Internet identifier, such as a nickname or even an email address, and a changing IP address representing a communication device as a user moves from one location to another. IP addresses are the identifiers used to route data packets across the Internet. For example, IP v.4 addresses are in the form of [x.x.x.x]. IP addresses represent physical nodes within a specific network, but may not be publicly accessible. In order to actually initiate communication to someone through an Internet device, its IP address and local port must be known. However, establishing communication to a device on a private network behind a Network Address Translation (NAT) router poses another problem. NAT is a method of providing multiple private IP addresses to Internet appliances behind a single publicly accessible IP address.

To date, large centralized servers that maintain a lookup table have been somewhat effective in solving these problems. The table maps a current IP address to these unique Internet identifiers that represent the person one may be trying to reach. This client-server model also solves the problem of connecting to devices behind a firewall with NAT routing because all communication typically flows through a server. A NAT router will allow bi-directional communication, but only if the client behind the NAT router on a private network initiates the communication. Most PM, or Instant Messaging services employing PM, require that the actual data transverse their servers. In this case, being on a private network behind a NAT router is not an obstacle to communication because the client first initiates communication with the server by logging on.

Although centralized servers might appear to be an effective solution, they have several disadvantages. First, a centralized server approach adds a network bottleneck in terms of data bandwidth, particularly for voice communications. A second problem with centralized presence servers concerns privacy and security issues. Any particular presence server could hold presence information for thousands of people. Those who have access to these servers also have access to a great deal of personal information such as your name, email address, etc. These servers could also log communication activities and your IP address that represents your current location. Finally, these servers must always be available for presence queries despite network traffic. Since they are centralized, particular networks or geographical areas may have difficulty providing a reliable connection.

Several voice-related companies are already using PM technology to offer new features to voice communication systems that provide the ability to contact people as they change from one location to another. PM may be defined as knowledge of the location of a particular contact based on their IP Address. At least one company presently offers a product that allows users to speak voice commands (for example, “Call Dr. Bauer”) and be instantly connected to the desired person (Dr. Bauer) wherever he is currently located. However, this system is based on a wireless device that must be worn by the user at all times. It also requires the use of an expensive central server, which must be located within the local network.

In such a voice-recognition based system, another problem becomes how to recognize proper names of those whom one may wish to contact. Independent speech recognition is the recognition of words, independent of the actual speaker. Dependent speech recognition is usually much more accurate, but a user must train the system by speaking the words before any recognition will take place. In terms of proper names, achieving independent voice recognition is extremely difficult due to their unique spellings and pronunciations. Furthermore, if dependent speech recognition is employed, there must exist a simple way to configure the system to associate a spoken name or contact (in other words, a voice signature) with an Internet address.

Although all these technologies provide useful features, current implementations are limited by clumsy and unnatural interfaces, or fail to provide a secure and effective peer-to-peer communication tool. There exists a need for a ubiquitous, hands-free communication interface based on distributed PM and voice recognition to engage with others more naturally.

### BRIEF DESCRIPTION OF THE DRAWINGS

FIG. 1 is a diagram illustrating two different presence management devices in accordance with embodiments of the invention.

FIG. 2 is a block diagram illustrating some major electronic components found in a presence management device in accordance with another embodiment of the invention.

FIG. 3 is a diagram illustrating how presence management devices in accordance with an embodiment of the invention might be implemented within a residential setting.

FIG. 4 is a schematic illustrating system operation according to embodiments of the invention.

FIG. 5 is a diagram illustrating a method for caching IP addresses in a distributed peer-to-peer model according to an embodiment of the invention.

FIG. 6 is a diagram illustrating a method for tracking a user as he or she moves about from room to room within a residence or building according to yet another embodiment of the invention.

### DETAILED DESCRIPTION OF THE INVENTION

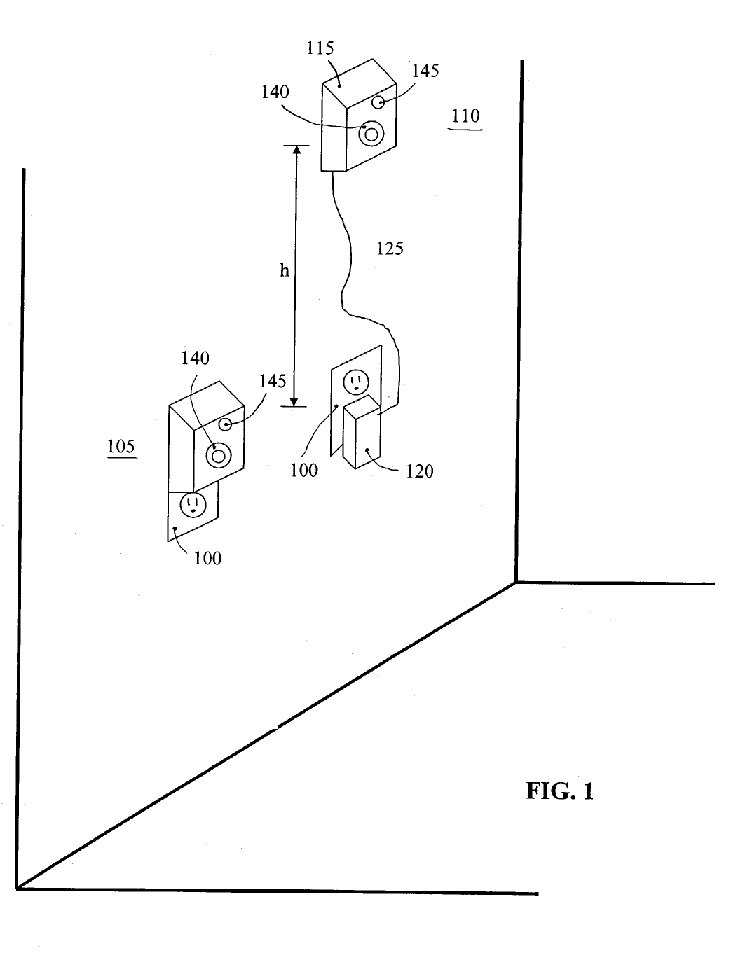

Embodiments of the invention will first be described in a general sense in order to convey an overall familiarity before describing in detail specific embodiments of the invention with respect to FIGS. 1-6. In the description that follows, embodiments of the invention are explained in the context of being used in conjunction with the Internet to perform communication functions. However, the Internet is used only as a familiar example and other embodiments of the invention may utilize other global networks that are less widely known or that do not currently exist today.

Embodiments of the invention provide a novel approach to facilitate full duplex, streaming VoIP communication, and half-duplex instant voice messaging for one-to-one or group chat capabilities. In the former case, voice data is streamed in real time to the remote client. In the latter case, users send short, recorded voice messages. In either case, a user engages with others by announcing her presence, indicating a remote user to contact, and then speaking naturally. The apparatus can connect to other similar remote devices or clients across the Internet or interface to existing VoIP and IM systems. Communication with remote clients is based on peer-to-peer networking.

A PM device in accordance with embodiments of the invention might resemble a small, lightweight speakerphone that plugs into any power outlet and is networked to other PM devices using home power lines or other networking technologies such as a wireless connection. Alternatively, PM devices in accordance with other embodiments of the invention may be portable among a variety of locations. A system of such PM devices within a residence or building provides a complete, hands-free communication environment that enables users to speak naturally and communicate with others as they move about from room to room.

Users interact with embodiments of the invention to send messages and configure the system. This is accomplished using speech recognition and simple voice commands and names that are recognized by the embodiment. Each user must train their own particular names and commands, but the training information is automatically replicated for other PM devices included in the system. A PC application or applet within a web browser is used for configuration to associate the spoken name with an Internet address.

The operation of embodiments of the invention may be further explained by functionally describing some of the processes that the various embodiments perform. These processes are described below in a certain order for ease of explanation. However, the particular order in which these processes are described is in no way meant to imply that one process must occur before another process, although in some situations that may be the case and will be apparent to those of ordinary skill in the art.

Embodiments of the invention perform an initial system setup process. In one system according to an embodiment of the invention, the system includes multiple PM devices that are installed by simply plugging one or more individual devices into any available electrical power outlet within a residence or other building. Each PM device is capable of communicating with other similar PM devices in a local network or in a remote network without using a server. Each PM device also maintains configuration information within its internal memory, so it may also operate independently of the other PM devices.

In alternative embodiments of the invention, PM devices may be implemented to work in conjunction with VoIP or IM applications running on a PC. In this case, the PM devices still perform features such as voice recognition, voice tracking, etc., but they communicate through existing applications. The PM devices extend the microphone and speaker interface and provide additional described features to these common PC applications anywhere within a building or residence. The PC could also be used to provide NAT capabilities, but these could also be provided with a router-based device.

In either case, network connections for each PM device may be provided over AC wiring using power line networking technologies such as those being developed by companies such as Intellon or Cogency, or by using wireless interfaces such as IEEE 802.11 or Bluetooth. A PM device will automatically attempt to acquire an IP address and configure itself. If Dynamic Host Configuration Protocol (DHCP) features are not available on a particular network, the PM device may be configured by an application running on a PC. In other embodiments, the PM devices may communicate and self-organize based on a networking protocol in order to assign unique network identifiers and establish a gateway connection to the outside world. In some embodiments of the invention, the PM devices will indicate a successful network connection with an LED or similar indicator.

In some embodiments of the invention, a PM device includes a microphone and a speaker contained in the same module, the module being plugged into an electrical outlet. In other embodiments, the physical location of the module can be adjusted according to user preferences while the module is still powered by the same electrical outlet. The module could either be mounted to the wall or rest upon a surface such as a table or desk. In either case, if multiple PM devices are to be installed, each device is preferably spaced evenly about the areas closest to where voices would be spoken naturally in a particular room.

After the initial system setup process, a proper name configuration process is performed by embodiments of the invention. In some embodiments of the invention, this requires only that the first PM device installed on the local network be initially configured, every other PM device installed on the network is configured with settings shared from the initial configuration. Each user of a PM device should perform this configuration since the embodiments respond to voice commands and are configured to recognize certain key words spoken by the user.

Since embodiments of the invention accommodate multiple users, each PM device has the ability to recognize the particular user that wishes to send or receive voice communication. This ensures that remote users can identify a caller and messages are received by the right person. In order to provide this feature, embodiments of the invention allow the user to register their spoken name with a PM device using voice commands. Afterwards it is necessary to associate that spoken name with an Internet identifier, typically an email address. In some embodiments, this association is performed by a configuration interface through an application running on a PC or an application running as an applet within a web browser.

The configuration interface provides a form in which users click on an unregistered voice signature and it is played using audio facilities on a PC. Then the user enters the corresponding Internet or email address in an associated text box. Additional communication management settings may also be configured through this interface.

Embodiments of the invention allow installation of additional PM devices on the same local network without any further configuration. When each new PM device is added, it sends an announcement to other PM devices that are already present. In response, the original configured PM device is triggered to send its configuration information to the new device. Consequently, all PM devices on the same network share the same configuration information.

In preferred embodiments of the invention, the first configuration step to be performed by each new user is voice signature registration. In order to register a user's name by voice, a user preferably speaks a command (eg, “register user”) that is detected by a microphone in one or more of the PM devices. The PM device then emits audible queues that step the user through the voice registration process. For example, the audible “interaction” between an unregistered user (Brian) and an embodiment of the invention may occur as shown below in Table 1. The specific audibles shown in Table 1 should not be taken as limiting in any way. For example, the user could use different commands to initiate user registration and the PM device could respond to user inputs by reproducing a human voice with the speaker, such as “confirmed.”

TABLE 1

| Origin of Audible | Audible |
|---|---|
| user | “Register User” |
| PM device | <beep> |
| user | “Brian” |
| PM device | <beep> |
| user | “Brian” |
| PM device | <beep beep> |

Embodiments of the invention may be further configured so that a user of one embodiment of the invention can speak with a remote user of another embodiment of the invention (a contact) by using voice commands. Similar to the voice signature registration of a new user, contact names are added by speaking the name of the contact and then configuring the respective voice signature through a web browser. The first step involves speaking a command (eg, “Add Contact”) that is detected by a microphone within one of the PM devices. The PM device then guides the user through the registration process using audible queues, such as those shown in Table 2 that are used to register a contact (eg, Stephanie). Embodiments of the invention allow contacts to be added at any time and in any order.

TABLE 2

| Origin of Audible | Audible |
|---|---|
| user | “Add Contact” |
| PM device | <beep> |
| user | “Stephanie” |
| PM device | <beep> |
| user | “Stephanie” |
| PM device | <beep beep> |

Before a user actually communicates with a contact by voice, the added contact name is first configured through a web browser. Again, the process is similar to the one used for registering a new user. The spoken signature of the contact name is associated with an Internet address such as an email address using a web browser interface. The association data is then stored within the PM device. Any number of contact names may be added at any time.

In addition to configuring a lookup between voice signatures and a more convenient Internet identifier or email address using a PC application or applet in a web browser, embodiments of the invention allow users to specify how they want to communicate with others, or have others initiate communication with themselves. This accounts for privacy considerations and a more natural voice interface. The described PC application or applet in a web browser also maintains a list of previously configured contacts and users. Any user of the local system may configure communication options through this interface or via voice commands.

Embodiments of the invention provide a number of communication options to users. Users may specify who may contact them during certain times of the day. Embodiments may also be configured such that a remote user might be permitted to initiate a VoIP call or send a message directly to the local user without any notification of such communication at the local apparatus. Conversely, embodiments may be configured to signal a unique tone, or actually play a message that speaks the name of the intended recipient and/or remote user initiating the communication.

In some embodiments, voice recognition configuration provides the ability to specify parameters or key words for voice commands. A communication to individual contacts could be uniquely specified by defining a key word to initiate and/or receive communications. As a non-limiting example, a user (Brian) may initiate a call to his sister (Stephanie) using one or more of the following spoken phrases: “Contact sister”, “Send a Message to, Stephanie”, or “Hi, sis.”

Embodiments of the invention allow all voice commands that register users or announce presence information to be configured by a user. Configuration of the commands themselves is similar to registering users and contacts, but a separate configuration window or form is provided to the users through the described configuration interface.

Embodiments of the invention also perform presence management for every user and for every contact by maintaining lookup facilities between a more conveniently remembered Internet identifier such as a nickname (“Bri”), an email address (brian44@aol.com), or a user name (brian44) and a dynamically changing IP address. Once a PM device detects a spoken command and a contact name (e.g., “Stephanie”), the embodiment looks up the IP address currently associated with the contact name and initiates communication with the remote PM device that is in the presence of the contact to acquire presence information about the contact. In conventional PM systems or Instant Messaging systems making use of PM, this task is achieved by using a centralized presence server that maintains a lookup table and tracks the IP addresses, for in some cases, thousands of people.

In some embodiments of the invention based on a distributed, peer-to-peer system, PM is achieved by maintaining both an internal primary cache of IP addresses of immediate contacts and a secondary IP address cache of those contacts' contacts. Each time a user changes location and announces their presence with another embodiment of the invention having a different IP address, the new IP address information is sent to all of the user's immediate contacts. The embodiment of the invention serving each contact then updates their cache of primary contacts and gains updated information about how to contact that particular user.

A problem arises if the contact's IP address is out of scope, meaning, the contact's embodiment is either turned off, or the contact is no longer using the embodiment with that particular IP address. In this case, the contact's remote embodiment does not receive the updated IP address information. However, the proper IP address information may still be determined by making a query to any other secondary contact (eg, the contact's contacts).

Thus, embodiments of the invention maintain a secondary cache where address information regarding a contact's contacts are stored. The secondary cache for any user is updated whenever a contact of that user changes their primary cache. When a user changes their primary cache, a notification is sent out to each contact so they can update their secondary cache with the new information. In this manner, embodiments of the invention can use the secondary cache to locate a contact if the contact's IP address is out of scope.

Under the current Internet Protocol version 4, which is widely used today to route data packets across the Internet, most local networks are private. Any Internet appliance, including embodiments of the invention, added to these networks will likely receive an IP address that is not publicly accessible. As the Internet matures and adopts IP v.6, a public IP address for each device connected to the Internet may be available. Until then, most peer-to-peer systems are forced to operate with NAT routed networks.

Embodiments of the invention solve the problem of initiating a connection to a device operating behind a NAT router by providing a customized NAT device or special software running on a personal computer. The customized NAT device provides the standard NAT capabilities for all other uses, but allows the routing of incoming connections to specific devices to be dependent upon configured port numbers. For example, a port 13680 may be configured to route to a private address 192.168.1.80. This configuration automatically occurs when embodiments of the system are first configured.

Conventional PM and Instant Messaging services that use PM also use the same centralized server for additional PM features. In contrast, embodiments of the invention send and receive presence information to and from remote embodiments, thus protecting the privacy of its users and providing a secure, more reliable service.

PM features provided by embodiments of the invention provide an efficient way to facilitate communication between users. A particular user can determine if the person or contact they are trying to reach is available before initiating communication to that contact. A user may also specify if he or she is willing to provide their own presence information, if he or she is available to be contacted by other users, or if he or she may be notified by specific contacts. These settings are configurable through the web interface once contacts have been added to the system. In a peer-to-peer system, this information is only shared with contacts specified through the configuration interface and does not pass through a centralized server architecture.

In some embodiments of the invention, the user announces his availability before he may be contacted by other users. Although other embodiments could be configured to allow anyone to contact users of a particular PM device or a number of different PM devices configured on a local network, it would be most desirable to only allow incoming communication from known contacts. Announcing one's availability to engage in communication may be done through a voice command. For example, a user Brian may indicate he can be reached by anyone specified in his contact list by speaking, for example, “Brian, here” or “Brian, available.” As Brian moves and changes location throughout the day, he simply needs to notify a PM device by speaking “Brian, here” or “Brian, available”. Should Brian prefer not to be contacted by anyone, he may similarly speak a command to a PM device such as, for example, “Brian, not here” or “Brian unavailable.”

Embodiments of the invention automatically update Brian's presence information by storing this information within the PM device itself and/or all other local PM devices. The PM device that receives Brian's spoken command will then send his current IP address and optionally, his availability status, to all contacts designated to receive presence information from Brian.

When a remote user tries to contact Brian, their device will determine if Brian is either available to accept the communication and initiate a call or the sending of a message based on the most current information stored in its memory. The device could also make another request from the contact to determine their availability if the information goes out of scope.

In alternative embodiments, the system has the ability to sense motion and thus request the user name and availability status if a new person is detected in the presence of a particular PM device. The embodiments may accomplish this by using speech cues or with simple beeps as the previous description has demonstrated.

For motion-sensing embodiments, a certain timeout period would likely be necessary to avoid repetitive availability requests if continued motion by the same user is present. The same is true if the system did not include motion detection but needed to decide if a user was still present in the location of a particular PM device but forgot to announce their availability status at a new location. Either way, embodiments maintain rules used to determine the availability of a user that are either specified by the user or that could be learned using technology such as neural networks.

Users frequently want to know whom they can contact at any one particular time, so some embodiments of the invention allow the user to request presence information about a contact at any time. For example, this could be accomplished by speaking the directive, “who's online?” or “who's there?” The embodiment then checks the availability of all those in the users contact list, playing back the recorded voice signatures of the contacts that are available to be contacted. This provides a simple method to stay in touch with friends and family in an informal and convenient manner.

After initial setup and configuration, other embodiments of the invention may allow users to place real-time VoIP calls to other remote users, or to Internet clients that support standardized protocols such as Session Initiation Protocol (SIP). A user may initiate communication by speaking a command to place the call followed by a contact name. The embodiment queries the availability of that user, if it was not provided, to enter the conversation by requesting presence data from the remote device or remote presence server. In order to be compatible with existing systems, embodiments might also query a presence server located somewhere on the Internet. If the contact is available, then the call is routed to the PM device or to the client where the contact is most closely located. If the contact is not available, a voice message may be left for the caller.

Table 3 is one possible non-limiting example of a user (Brian) initiating a phone call to a contact (Stephanie).

TABLE 3

| Origin of Audible | Audible |
|---|---|
| user | “Place to call to Stephanie” |
| PM device | <beep> |
| user | “(conversation with Stephanie)” |
| user | “End call to Stephanie” |
| PM device | <beep beep> |

On the receiving side, the audibles between the remote contact (Stephanie) and another PM device might be as given in Table 4.

TABLE 4

| Origin of Audible | Audible |
|---|---|
| PM device | <“Incoming call from Brain”> |
| contact | “accept” |
| contact | “(conversation with Brain)” |
| PM device | <“call from Brian complete”> (after |
| | Brian ends the call) |

Stephanie may alternatively decline the call and instead route the call into a message box. Still other embodiments of the invention could be configured so that no status information is output from the PM devices when receiving a call or message from particular contacts. In other words, Brian and Stephanie of the above example could simply begin talking. In yet other embodiments, the actual voice signature for “Brian” spoken in the voice of the remote contact may also be shared when presence information is exchanged.

Embodiments of the invention may also allow users to send voice messages. This is done in a way similar to that of placing a call as was explained in Table 3 and Table 4 above. However, unlike placing a call, voice messages may be sent despite the unavailability of the contact. If the intended contact is unavailable, the server may return a confirmation acknowledgement to the user once the contact actually receives the message. Table 5 illustrates one non-limiting example of a user (Brian) sending a voice message to a contact (Stephanie).

TABLE 5

| Origin of Audible | Audible |
|---|---|
| user | “Message, Stephanie” |
| PM device | <beep> |
| user | “Hi, how are you?” |
| PM device | <beep beep> |
| user | “Send message to Stephanie” |

In order to provide a natural communication environment in which users can engage in real-time voice communication or send messages, some embodiments of the invention may allow different PM devices to act cooperatively to track the speaker while she is talking or listening. These embodiments optimize the signal quality of acquired speech by determining the optimum PM device from which the voice communication should take place or facilitate the processing of combined signals gathered from more than one PM device. These embodiments also provide a unique listening environment for the users because the speech from the remote contact may be reproduced among several PM devices, simulating the acoustics as if the contact was actually communicating in the same room or locale as the user.

In the case where a user is speaking to a contact, each PM device surrounding the user utilizes only its microphone element. One implementation simply involves determining the optimum PM device that is currently receiving the best signal based on amplitude or some other means and rely upon that particular device for communication. As the user moves from location to location, the optimum PM device frequently changes. As the optimum PM device changes, the “new” optimum PM device will signal the other PM devices included in the embodiment that it is now the active device for speech acquisition.

Other embodiments may feature the combination of speech signals. Similar to a microphone array used for some speech recognition programs that run on PCs, the signal-to-noise ratio is maximized by correlating the incoming speech signals to reduce noise. In one example embodiment, a particular PM device might act as a master device with the other PM devices sending acquired speech data to this particular device for signal processing over the network.

In the case when the user is listening to a contact through sound reproduced by the PM device, the active PM device is still preferably chosen based on the strength of the voice signal received from the user. However, if a particular user is not speaking, and only listening, it becomes much more difficult to determine the optimum PM device for this user. In such situations, each device may also respond to a voice command such as “I'm over here,” or emit a voice query such as “Are you still there?” to prompt for voice such that the local devices can determine the best new active PM device.

Embodiments of the invention may also be configured so that in a multi-party conversation, voice reproduced by the device may be directed from specific areas around the user to further simulate a natural communication environment with more than two people. Under this configuration, each PM device is associated to a specific connection with a remote contact and reproduces only the voice from that contact. Alternatively, a group of the PM devices could acoustically simulate directional audio from multiple contacts.

Embodiments of the invention may also employ neural network technology so that the various rooms a user is likely to transverse may be learned. This is particularly important so that if a noise is picked up in another room, the active PM device is not automatically transferred to that room absent any movement on the part of the user. A new voice detected in a separate or distinct room may be qualified in such that the local PM device closest to the new voice could prompt the new user to speak their user name before they could enter the conversation. This feature would protect the privacy of the current conversation while also providing a means for new users to join the conversation.

At this point several specific embodiments of the invention will be described with reference to FIGS. 1-6. These embodiments are not meant to be limiting in any way, but are rather for developing a fuller understanding of the inventive aspects of the invention.

A PM device in accordance with embodiments of the invention may encompass any number of physical forms. FIG. 1 is a diagram illustrating the physical configuration of two possible presence management devices in accordance with embodiments of the invention.

In FIG. 1, two electrical outlets 100 are located on a wall. Plugged directly into one electrical outlet 100 is a PM device 105 that includes a speaker 140 and a microphone 145 housed within the PM device 105. The speaker 140 is arranged to transmit audible signals into the area surrounding the PM device 105 and the microphone is arranged to receive audible signals produced in the same area. The PM device also houses a network interface (not shown) compatible with power line networking technologies such as those being developed by companies such as Intellon or Cogency. Alternatively, the network interface may be a wireless interface such as IEEE 802.11 or Bluetooth.

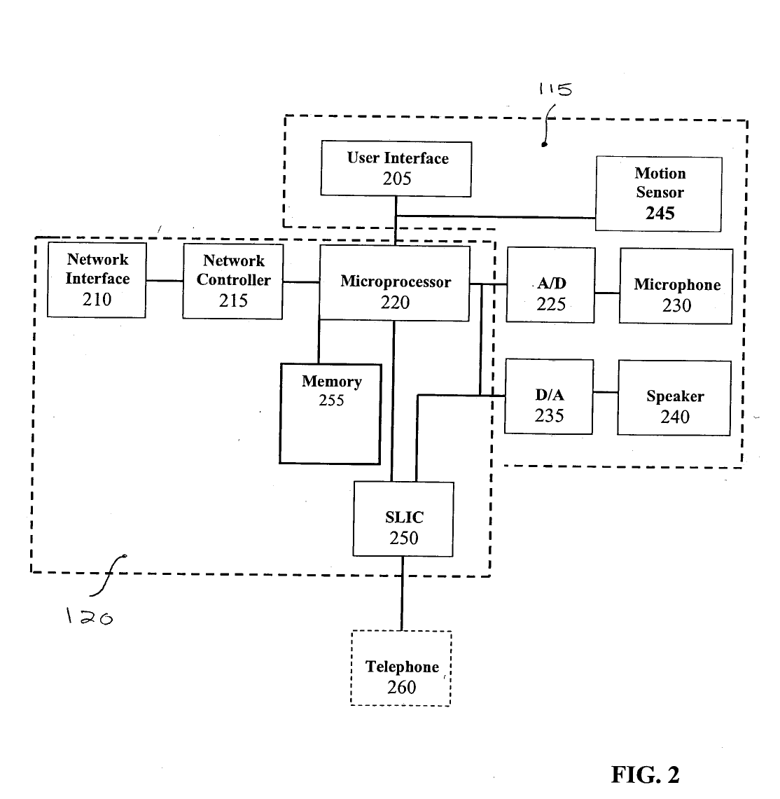

Another PM device 110 according to an embodiment of the invention includes a control unit 120 attached to the other electrical outlet 100 and a sensor unit 115 attached to the control unit 120 by the umbilical 125. The control unit 120 contains a majority of the electronic subsystems, including the network interface (not shown). These other components will be shown later in FIG. 2. The control unit 120 plugs directly into the electrical outlet 100 for both power and networking requirements.

With the PM device 110, the user may adjust the position of the sensor unit 115 to a desired location (such as head level) by affixing the module 115 to the wall or by allowing it to rest on a flat surface. This flexibility optimizes the ease of use.

Similar to the other PM device 105, there is a speaker 140 and a microphone 145 housed within the sensor unit 115 of the presence management device 110. In other embodiments of the invention, the sensor unit 115 and the control unit 120 may be structured in a variety of shapes, sizes, and colors. It is also contemplated that PM devices in accordance with other embodiments of the invention may include provisions to connect an analog telephone to the PM device.

FIG. 2 is a block diagram illustrating some major electronic components found in a PM device 110 in accordance with an embodiment of the invention. FIG. 2 assumes that the PM device has the physical configuration of the PM device 110 in FIG. 1. In FIG. 2, block 120 represents the components housed in the control unit 120 of FIG. 1 and block 115 represents the components housed in the sensor unit 115 of FIG. 1.

The control unit 120 contains a network interface 210, a network controller 215, a microprocessor 220, a memory 255, and a subscriber line interface circuit (SLIC) 250 that may be attached to an analog telephone 260 that is external to control unit 115. Attaching an analog telephone 260 to the PM device in this manner would provide a more familiar interface for those who are uncomfortable with the voice-recognition technology or who wish to shield their voice from others within hearing range.

The network interface 210 is preferably a home power line data network media. However, a variety of network interfaces such as Ethernet, HomePNA (phoneline networking alliance), or wireless is acceptable. The network controller 215 is responsible for sending and receiving audio and control data to and from the network. Using a power line adapter simplifies the wiring requirements since both the power and data lines are the same.

In the sensor unit 115, there is housed a microphone 230 for acquisition of voice audio data for command recognition and a speaker 240 for reproduction of voice audio data. The speaker 240 is required to reproduce the audio data received from remote contacts or to signal some event to the user. An A/D converter 225 provides a digital signal to the microprocessor 220 in the control unit 120. Likewise, the interface between the microprocessor and the speaker requires a D/A converter 235 and a small amplifier (not shown) to convert and amplify the digital audio signal.

There is also a user interface 205 on the sensor unit 115. The user interface 205 accepts inputs from a user and conveys status information using any combination of buttons, LEDs, and small graphic displays. For instance, a button may be used to turn the device on or off, or to help configure the device. A graphical user display may textually identify the name of a person who is trying to reach the user. Also included in the sensor unit 115 is a motion sensor 245 that enables the PM device 110 to detect the presence of individuals even when they are silent. In alternative embodiments this ability may be incorporated into a security system or it may allow the PM device 110 to query individuals as to whether they wish to communicate with others.

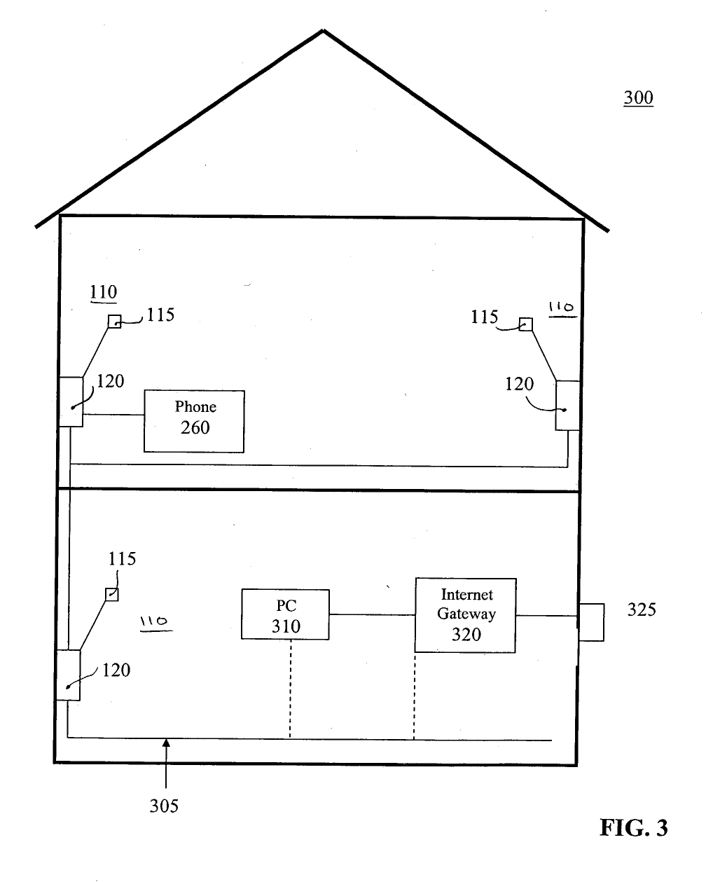

FIG. 3 is a diagram illustrating how several presence management devices 110 from FIG. 2 may be arranged into a system 300 implementing internet connectivity within a residential setting in accordance with an embodiment of the invention. With reference to FIG. 3, the PM devices 110 (each having a control unit 120 and a sensor unit 115) are powered by home power lines 305 which are also used as a data communication network. The PM devices 110 are connected to the network using any one of a variety of physical media such as Ethernet, PowerLine, HomePNA, or wireless. A power line connection is the preferred connectivity method because the PM device 110 may acquire power and networking connections from a single source. An Internet gateway device 320 provides the actual access point to the Internet and would typically be a digital subscriber line (DSL) or Cable router that connects to the telephone or cable junction 325 outside the residence.

Multiple PM devices 110, each having a distinctive Internet Protocol Address (IP address), can co-exist on the same network. If the PM devices 110 are not able to acquire a uniquely identifiable, public Internet address, then in order to perform peer-to-peer communication they are used behind a router that provides IP masquerading or Network Address Translation (NAT). A PC 310 may also be used as such a router to provide these capabilities.

The NAT features provided by either the dedicated router device or PC include both standard NAT features and the ability to route incoming calls to private IP addresses based on a particular port. In both cases, an Internet gateway 320 is used to route the TCP/IP data across the Internet 420.

The system 300 may also be configured to interface with a PC for communication services. As described, PM devices are capable of communicating with common VoIP or IM applications to extend the microphone and speaker interface away from a PC. Since the PC application perform all remote communications with other PM devices or other PCs on behalf of a particular PM device or an impromptu network of multiple PM devices, this method will be referred to as the proxy mode of operation.

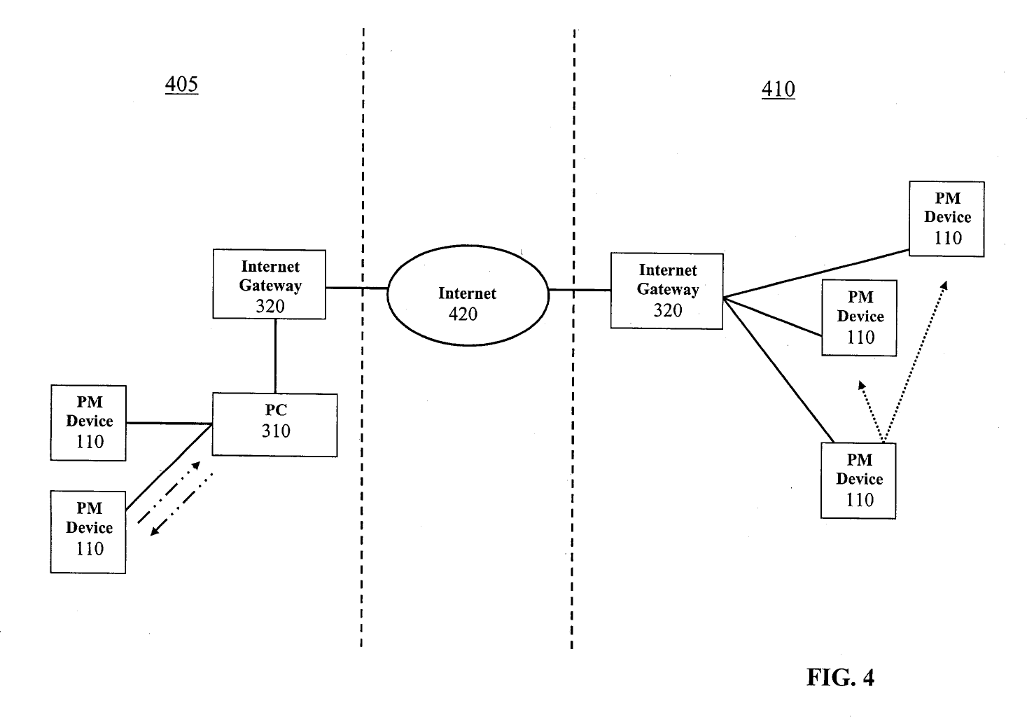

The modes of operation described above according to some of the embodiments of the invention will now be described with reference to FIG. 4. FIG. 4 illustrates a proxy mode of operation 405 in which a PC 310 functions as a proxy server and manages all messages sent or received to or from remote devices or PC applications according to the particular application or application protocol. Under the proxy mode of operation, when PM devices would otherwise send an outgoing presence request or attempt to establish an outgoing call, the device sends this message to the local PC running a communication application. An interface application runs on the local PC that is listening for message requests from local PM devices. This interface application then translates messages from the PM devices into program calls, such as those into a DLL, directly into the PC applications. The PC application then uses its connection to remote presence servers or other infrastructure to establish communication channels or check presence information.

FIG. 4 also illustrates an independent mode of operation where PM devices 110 can function independently of a PC. In this method of operation, the PM devices only require an Internet gateway 320 to send and receive messages directly to and from other PM devices across the Internet 420 or other global network. Presence and call establishment request messages are sent directly to the device given the IP address representing the particular device in the proximity of the contact a user wants to reach.

The initial setup of a presence management system in accordance with embodiments of the invention is straightforward. With reference to FIG. 1, a user simply plugs a PM device 105 or 110 into any electrical outlet in the home if a power line network is used. Returning to FIG. 4, a PM device 110 must first acquire an IP address for future communication by making a DHCP request from either the NAT enabled Internet gateway 320 or by making a DHCP request from the ISP in the independent mode of operation. Otherwise, each device will send out a broadcast request to other PM devices.

After the PM device 110 acquires an IP address, it will immediately try to establish a connection to the outside world to determine if the network is properly configured. Depending on the result, small indicators such as green or red LEDs may be lit to indicate if the initial setup was successful or not.

After the PM 110 device has an IP address and the initial setup is complete, any further configuration may be performed using a configuration interface running on a PC application or web browser such as Microsoft Internet Explorer, or Netscape Communicator with an embedded applet. This configuration method consists of adding users (those who will use the local system) and contacts (those who may be contacted by the local system) through voice commands and then associating them to an Internet identifier, which is typically an email address. The voice signatures are stored in the non-volatile memory of each PM device 110. A PC application or web browser running an applet then broadcasts to the local network and a master PM device is determined based on the location of the user. The configuration process, (process of adding users and contacts) then takes place with the master device. Once the configuration is complete, the master PM device sends a broadcast message to other PM devices on the same local network to update their configuration information.

According to some embodiments of the invention, in order to initiate communication like placing a call to a remote contact or sending a voice message to a remote contact, the user of the PM device speaks a voice command. Examples of such voice commands have be described previously. The PM device 110 that receives the voice command will perform a speech recognition function in order to decipher the user's wishes. In some cases in the proxy mode of operation 405, the PM device 110 only detects and records the audible sample. In these cases the speech sample is then sent to the PC proxy server in order to process the captured audible signal. With either method, once the speech sample is recognized, the PM device 110 is capable of executing the command and is made aware of the Internet identifier, such as an email address, belonging to the intended contact.

At this point, the PM device 110 queries the contact for presence information or relies upon stored presence information previously received from the contact to determine the availability of the contact. Once this information is known, the user's spoken communication or voice message is packed into buffers and sent directly to the remote contact.

At the remote site, if a private network configured behind a NAT router is used, the gateway device or PC determines which PM device 110 should be notified of the incoming communication for a particular contact based on the port number that was previously configured. When contacts announce their presence by voice, or alternatively when the PM devices 110 detect the presence of a contact via motion detection, this information is maintained in each device. Therefore, each PM device embeds information into the message sent by the remote user to properly route the incoming notification. Once the proper PM device 110 in the presence of the contact receives the notification, the PM device 110 itself will notify the contact via an audible signal that a remote user wants to engage in communication. Individual PM devices 110 may be configured to use audible signals such as beeps, tones, music, or voices to notify the contact that the remote user wants to engage in communication. The contact then has the option to accept or decline the communication via a voice command.

In order to provide a distributed IP address-to-name configuration mechanism in a peer-to-peer network, embodiments of the invention employ a primary and secondary caching system. In such a system, each PM device maintains a primary IP address cache of its contacts configured through voice commands and/or a special PC program or applet running through a web browser.

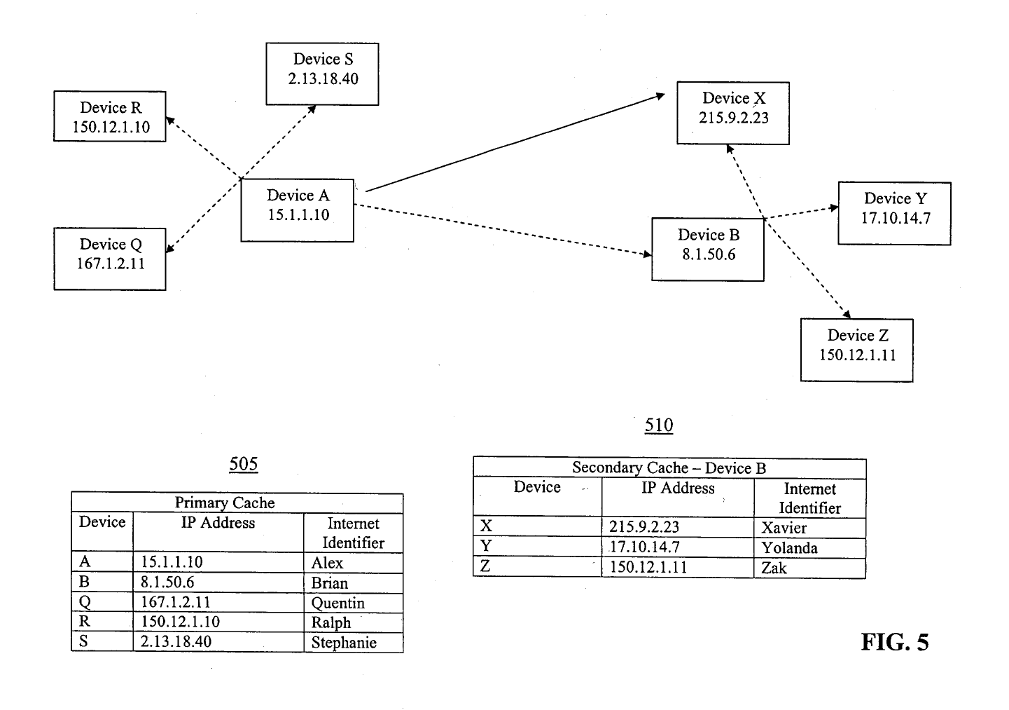

FIG. 5 is a block diagram illustrating the primary and secondary IP address caching scheme according to some embodiments of the invention. In FIG. 5, a number of PM devices A, B, Q, R, S, X, Y, and Z are shown, each PM device having its own local IP address. Each of the PM devices A, B, Q, R, S, X, Y, and Z may be physically the same as the PM devices 105 and 110 shown in FIG. 1 or they may be a mix of similar devices in keeping with embodiments of the invention. The dotted arrows connecting Device A to Devices B, Q, R, and S indicate that Devices B, Q, R, and S are contacts of Device A. That is to say, a user in the presence of Device A currently has potential contacts in the presence of Devices B, Q, R, and S. Similarly, the dotted arrows connecting Device B to Devices X, Y, and Z indicate that a user in the presence of Device B has potential contacts in the presence of Devices X, Y, and Z.

Device A has a primary cache 505. The first entry in primary cache 505 is the local IP address of Device A itself. Subsequent entries for Devices B, Q, R, and S map contact names and their respective Internet identifiers to a unique IP address.

Associated with each primary cache entry is a secondary cache that helps to maintain the primary cache entry for a particular contact. For example, Device A's secondary cache 510 is the secondary cache for Device A's primary cache entry for Device B. Secondary cache 510 is also the primary cache for Device B.

For example, if a user currently associated with Device A (e.g., Alex) wished to communicate with a contact associated with Device B (e.g., Brian), normally Device A simply refers to its primary cache 505 to find the current IP address for Brian. However, Device A's primary cache entry for Brian may be invalid because Brian is out of scope. In other words, Brian may have moved out of the presence of Device B, in which case Device B alerts Device A to this fact. Device B also supplies Device A with its current primary cache listing, which becomes Device A's secondary cache 510. Using the secondary cache 510, Device A begins to query the Devices X, Y, and Z to determine if Brian's presence has been detected, and Devices X, Y, Z can determine if this is the case from their own primary caches. If Brian has been detected, Device A acquires Brian's current IP address from Device X, Y, or Z, updates its primary cache 505, and voice communication between Alex and Brian may be initiated.

For the system to work in such a distributed fashion, each PM device makes a best effort attempt to alert all other devices in its primary cache when any of its primary cache contacts change IP address locations. In turn, each of these devices updates its secondary cache with the new primary cache information from the alerting device.

Embodiments of the invention also provide voice-tracking capabilities and an environment that simulates a real conversation as if all parties engaging in conversation were present in the same room. According to embodiments of the invention, each presence management device is capable of communicating with other PM devices in order to determine the best particular device or combination of devices for voice acquisition and playback.

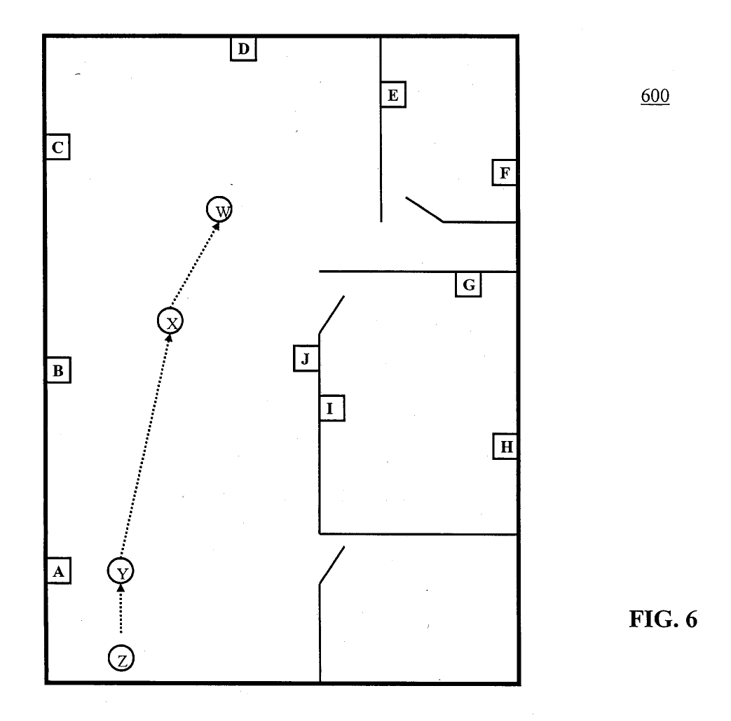

FIG. 6 is a diagram illustrating a method for tracking a user as he or she moves about from room to room within a residence or building according to another embodiment of the invention. In FIG. 6, there are a number of PM devices A-J located at various locations within a building 600, each PM device on the same local network.

Referring to FIG. 6, a user enters building 600 at point Z. This particular user then issues a voice command to contact a friend while walking past point Y in route to point X. At that particular point in time, devices A, B, and J all received the command to connect the user with his friend and establish a call. However, only one device should actually make the connection. The situation is mitigated by each device sending a status packet to the other devices on the local network immediately after receiving the recognized command. This status packet contains information relating to the quality and confidence level of the recognized command. The device that received the highest quality signal with the greatest confidence level is self-elected the master device and the connection is made with that particular device.

Suppose now device A was elected the master device and the call was established. Now the user walks forward as he or she begins a conversation with the called party. As the user moves about, the signal received by device A begins to fade, but the signal at device B and J begin to intensify. Periodically, each device receiving an active signal it can distinguish from a noise level will send a status packet to the other devices indicating the quality level of the signal. This information is used by each device to determine whether to relinquish active control of voice acquisition, keep it, or share the control with another device.

The actual status packet sent among the devices would typically include data such as the device IP address, signal quality, confidence level of received commands, and other network performance information like that included in Real Time Control Protocol (RTCP) information. The status packet also provides information about the current master device.

Continuing with the present example, in another embodiment of the invention, as soon as the signal received by device B is greater than that received by A, device B becomes the active or master device. Alternatively, device A and B may work together to both acquire and reproduce the voice audio signal received from the user and network, respectively. Various signal processing algorithms could be employed to acquire the best signal possible from the user. In this case, one device would still be elected a master and the associated slave device would send its data to the master to do the signal processing. In yet another embodiment, all data could be sent to a dedicated server device for processing. Finally, voice data received by the devices could also be split or reproduced by more than one device to provide better acoustics within a room.

Finally, in a multi-user conversation, separate PM devices may be used to simulate directional acoustics of actual people in the same room. For example, suppose a user was in a conversation with four remote contacts. If the user now moved into position W, devices B, C, D, and J could each handle processing conversation data for a corresponding remote contact. In this case, voice acquisition could still be handled based on the above description and the user voice data would be multi-cast to the other four contacts in the conversation. However, the voice data received from those other four contacts would be directed, potentially handled independently, and reproduced by a separate device in the vicinity of the user.

Although several embodiments of the invention have been described in the disclosure, these examples are not meant to be limiting in any way, as various modifications and adjustments will be apparent to those skilled in the art. I claim all embodiments within the scope and breadth of the following claims.

1. A presence management apparatus structured to provide a hands-free communication interface between a user and a contact based on voice recognition and structured to work cooperatively with other presence management apparatus in a peer-to-peer fashion to form an impromptu network, the apparatus comprising:
a sensor unit structured to gather signals from the user; and
a control unit structured to process signals gathered by the sensor unit, structured to interface with a global network; and structured to exchange data with a network communication device, wherein the network communication device includes another presence management apparatus.

2. The apparatus of claim 1, further comprising:
a housing that contains the sensor unit, that contains the control unit, and is structured to plug directly into an electrical outlet.

3. The apparatus of claim 1, further comprising:
a first housing that contains the control unit and is structured to plug directly into an electrical outlet; and
a second housing that contains the sensor unit and that is electrically connected to the first housing.

4. The apparatus of claim 1, the control unit comprising:
a network interface configured to communicate with a remote server;
a processor configured to recognize a spoken command from the user, to associate a voice signature from the user with an internet identifier, to map the internet identifier to a physical address on the global network, and to control communications with the contact in response to the spoken command; and
a memory structured to store configuration information that includes the voice signature, the internet identifier, and the physical address.

5. The apparatus of claim 4, wherein the remote server is a device selected from the group containing a communication server, an Internet search engine, a voice over internet protocol (VoIP) gateway, and a presence server.

6. The apparatus of claim 1, the control unit additionally configured to exchange data with a personal computer running a communication application.

7. The apparatus of claim 6, wherein the communication application is chosen from the group consisting of a voice over internet protocol application and an instant messaging application.

8. The apparatus of claim 4, the network interface configured to connect to mobile telephones, land-line telephones, and voice-mail boxes.

9. The apparatus of claim 1, the sensor unit comprising:
a motion detector.

10. The apparatus of claim 1, wherein the control unit is additionally configured to detect a valid signal gathered by the sensor unit based on a volume threshold exceeding a time averaged level.

11. The apparatus of claim 1, wherein the control unit is additionally configured to detect when a valid signal is gathered by the sensor unit and by a sensor unit belonging to another presence management apparatus that shares a local network with the apparatus by using a learning mechanism employing a neural network.

12. The apparatus of claim 1, the sensor unit comprising:
a graphic display structured to indicate the identity of the remote contact.

13. A method of hands-free communication between a user and a contact over a global network in a peer-to-peer fashion, the method comprising:
detecting the user within the vicinity of a first presence management device;
detecting a spoken command and a spoken contact name from the user with the first presence management device;
detecting the contact within the vicinity of a second presence management device in response to the spoken command and the spoken contact name;
determining a contact availability in response to the spoken command and the spoken contact name;
opening a communication channel between the first presence management device and the second presence management device in response to the spoken command, the spoken contact name, a contact presence, and the contact availability.

14. The method of claim 13, where instead of opening a communication channel between the first presence management device and the second presence management device, the method further comprises:
transmitting a user's voice message from the first presence management device to the second presence management device in response to the spoken command, the spoken contact name, the contact presence, and the contact availability; and
storing the user's voice message in the second presence management device.

15. The method of claim 13, wherein detecting a user within the vicinity of a first presence management device comprises:
registering the user by storing a user voice signature in the first presence management device; and
comparing an audible signal detected by the first presence management device to the user voice signature.

16. The method of claim 13, wherein detecting a user within the vicinity of a first presence management device comprises:
registering the user by storing a user voice signature in a third presence management device that is connected to the first presence management device by a local network;
sending the user voice signature to the first management device; and
comparing an audible signal detected by the first presence management device to the user voice signature.

17. The method of claim 13, wherein detecting a contact within the vicinity of a second presence management device in response to the spoken command and the spoken contact name comprises:
associating the spoken contact name with an internet identifier belonging to the contact;
associating the internet identifier with a global network address that belongs to the second presence management device; and
transmitting contact presence information from the second presence management device to the first presence management device in response to a query from the first presence management device.

18. The method of claim 17, further comprising:
transmitting another global network address belonging to a third presence management device from the second presence management device to the first presence management device when the contact presence information indicates that the contact is not within the vicinity of the second management device.

19. The method of claim 17, wherein associating the spoken contact name with an internet identifier belonging to the contact comprises:
prior to initiating communication with the contact, storing the internet identifier and associating the internet identifier with the spoken contact name using a configuration interface.

20. The method of claim 19, wherein storing the internet identifier and associating the internet identifier with the spoken contact name using a configuration interface comprises running a software application on a device that is connected to the first presence management device by a local network.

21. The method of claim 13, wherein determining a contact availability in response to the spoken command and the spoken contact name comprises:
notifying the contact with the second presence management device that the user seeks to establish the communication channel.

22. The method of claim 13, wherein opening a communication channel between the first presence management device and the second presence management device in response to the spoken command, the spoken contact name, a contact presence, and the contact availability comprises:
opening the communication channel without notifying the contact that the user seeks to establish the communication channel when the contact has previously signaled to the second presence management device that contact availability exists with respect to the user.

23. The method of claim 13, further comprising:
detecting the contact within the vicinity of a third presence management device; and
opening another communication channel between the first presence management device and the third presence management device.

24. The method of claim 13, wherein the spoken command and the spoken contact name are changed according to a preference of the user using a configuration interface, the configuration interface including a software application, while a function belonging to the spoken command and the contact indicated by the spoken contact name remain the same.

25. The method of claim 13, further comprising:
dynamically mapping a first global network address of at least one presence management device in proximity to the user to a first global network identifier associated with the user as the user moves among a first plurality of presence management devices; and
dynamically mapping a second global network address of at least another one presence management device in proximity to the contact to a second global network identifier associated with the contact as the contact moves among a second plurality of presence management devices.
